(19) United States
(12) Patent Application Publication
(10) Pub. No.: US 2021/0195358 A1
(43) Pub. Date: Jun. 24, 2021

(54) CONTROLLING AUDIO RENDERING

(71) Applicant: Nokia Technologies Oy, Espoo (FI)

(72) Inventors: Francesco Cricri, Tampere (FI); Arto Lehtiniemi, Lempäälä (FI); Antti Eronen, Tampere (FI)

(21) Appl. No.: 16/077,856

(22) PCT Filed: Feb. 15, 2017
(86) PCT No.: PCT/FI2017/050092

§ 371 Date: Aug. 14, 2018

(30) Foreign Application Priority Data
Feb. 16, 2016 (EP) 16156591.6

(51) Int. Cl. H04S 7/00; H04S 3/00

(52) U.S. Cl. CPC H04S 7/301; H04S 3/008; H04S 7/303; H04S 2400/13; H04S 2400/15; H04S 2400/01; H04S 2400/11

(57) ABSTRACT

A method comprising: remotely sensing a real acoustic environment, in which multiple audio signals are captured; and enabling automatic control of mixing of the multiple captured audio signals based on the remote sensing of the real acoustic environment in which the multiple audio signals were captured.

### TECHNOLOGICAL FIELD

Embodiments of the present invention relate to controlling audio rendering. In particular, they relate to controlling audio rendering of a sound scene comprising multiple sound objects.

### BACKGROUND

A sound scene in this document is used to refer to the arrangement of sound sources in a three-dimensional space. When a sound source changes position, the sound scene changes. When the sound source changes its audio properties such as its audio output, then the sound scene changes.

A sound scene may be defined in relation to recording sounds (a recorded sound scene) and in relation to rendering sounds (a rendered sound scene).

Some current technology focuses on accurately reproducing a recorded sound scene as a rendered sound scene at a distance in time and space from the recorded sound scene. The recorded sound scene is encoded for storage and/or transmission.

A sound object within a sound scene may be a source sound object that represents a sound source within the sound scene or may be a recorded sound object which represents sounds recorded at a particular microphone. In this document, reference to a sound object refers to both a recorded sound object and a source sound object. However, in some examples, the sound object may be only source sound objects and in other examples a sound object may be only a recorded sound object.

By using audio processing it may be possible, in some circumstances, to convert a recorded sound object into a source sound object and/or to convert a source sound object into a recorded sound object.

It may be desirable in some circumstances to record a sound scene using multiple microphones. Some microphones, such as Lavalier microphones, or other portable microphones, may be attached to or may follow a sound source in the sound scene. Other microphones may be static in the sound scene.

The combination of outputs from the various microphones defines a recorded sound scene. However, it may not always be desirable to render the sound scene exactly as it has been recorded. It is therefore desirable, in some circumstances, to enable a post-recording adaptation of the recorded sound scene to produce an alternative rendered sound scene.

### BRIEF SUMMARY

According to various, but not necessarily all, embodiments of the invention there is provided a method comprising: remotely sensing a real acoustic environment, in which multiple audio signals are captured; and enabling automatic control of mixing of the multiple captured audio signals based on the remote sensing of the real acoustic environment in which the multiple audio signals were captured.

According to various, but not necessarily all, embodiments of the invention there is provided an apparatus comprising: at least one processor; and at least one memory including computer program code the at least one memory and the computer program code configured to, with the at least one processor, cause the apparatus at least to perform: enabling automatic control of mixing of multiple captured audio signals based on remote sensing of a real acoustic environment in which the multiple audio signals were captured.

According to various, but not necessarily all, embodiments of the invention there is provided a computer program that when run on a processor performs: enabling automatic control of mixing of multiple captured audio signals based on remote sensing of a real acoustic environment in which the multiple audio signals were captured.

According to various, but not necessarily all, embodiments of the invention there is provided an apparatus comprisingL means for remotely sensing a real acoustic environment, in which multiple audio signals are captured; and means for automatically controlling mixing of the multiple captured audio signals based on the remote sensing of the real acoustic environment in which the multiple audio signals were captured.

According to various, but not necessarily all, embodiments of the invention there is provided examples as claimed in the appended claims.

### BRIEF DESCRIPTION

For a better understanding of various examples that are useful for understanding the detailed description, reference will now be made by way of example only to the accompanying drawings in which:

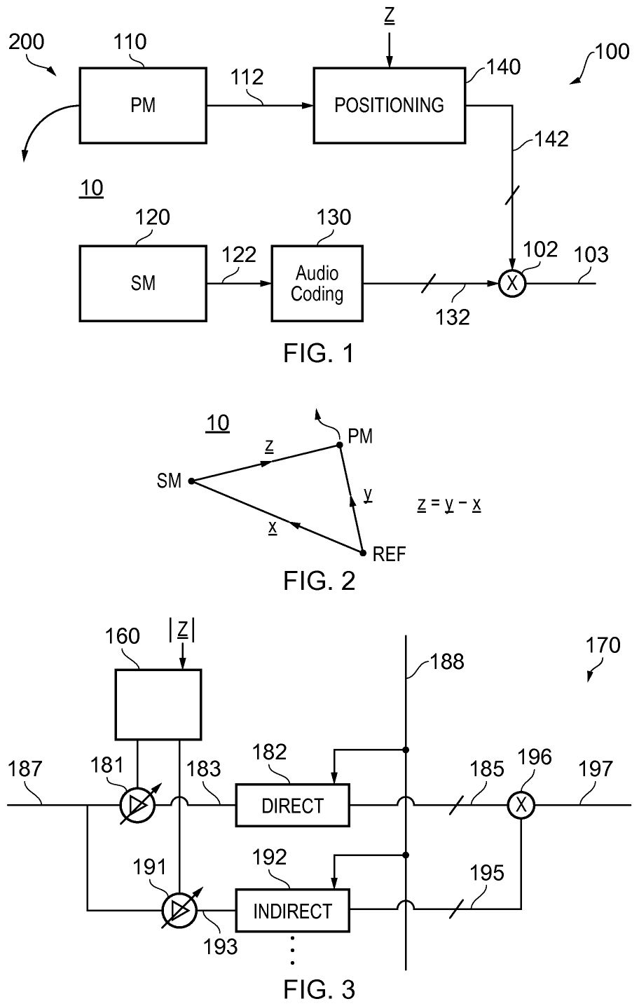

FIG. 1 illustrates an example of a system and also an example of a method for recording and encoding a sound scene;

FIG. 2 schematically illustrates relative positions of a portable microphone (PM) and static microphone (SM) relative to an arbitrary reference point (REF);

FIG. 3 illustrates a module which may be used, for example, to perform the functions of the positioning block, orientation block and distance block of the system;

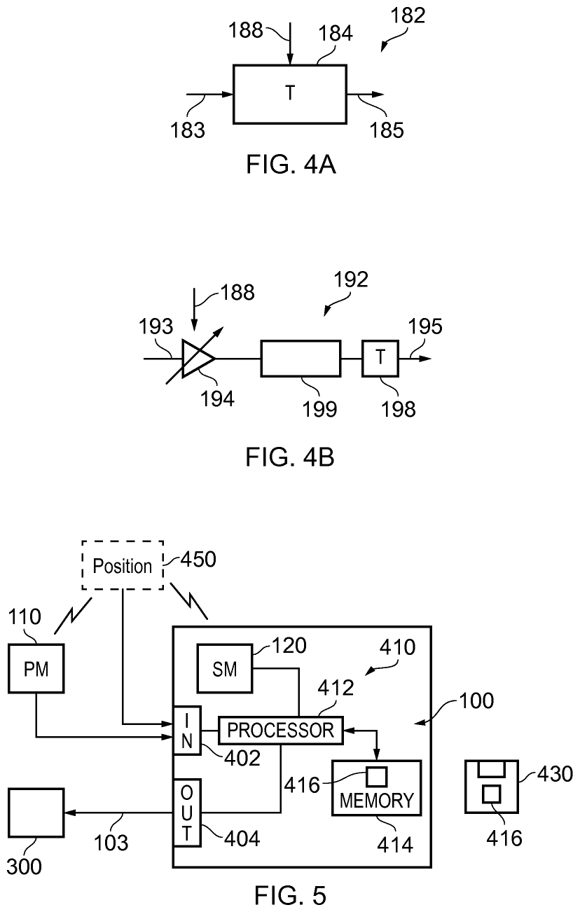

FIGS. 4A and 4B illustrate examples of a direct module and an indirect module for use in the module of FIG. 3;

FIG. 5 illustrates an example of the system implemented using an apparatus;

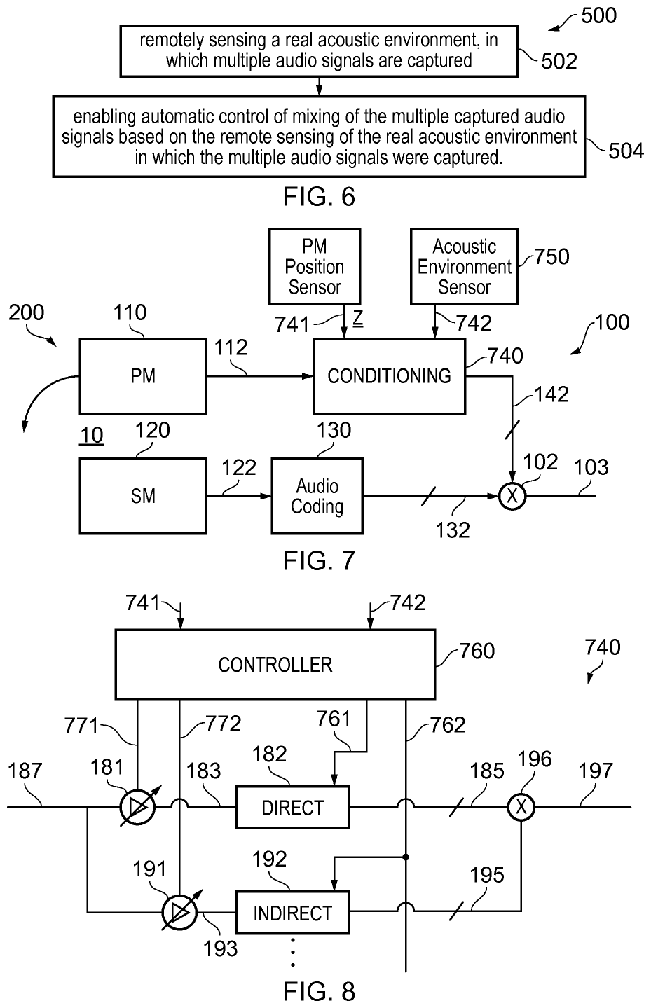

FIG. 6 illustrates an example of a method for enabling automatic control of mixing of multiple captured audio signals based on remote sensing of a real acoustic environment;

FIG. 7 illustrates an example of a system and also an example of a method for recording and encoding a sound scene by automatically conditioning an audio signal from a portable microphone in dependence on remote sensing of a real acoustic environment;

FIG. 8 illustrates a module which may be used, for example, to perform conditioning of an audio signal in dependence on remote sensing of a real acoustic environment;

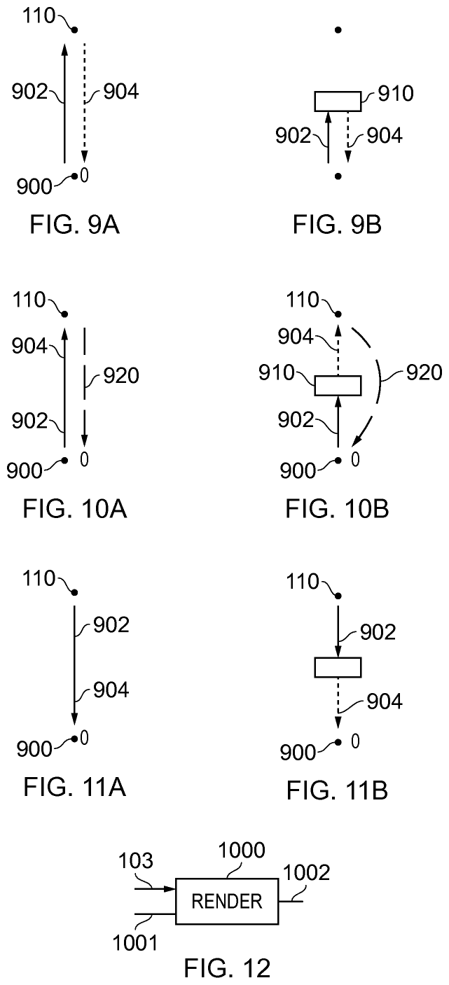

FIGS. 9A, 9B illustrates an example of automatic control of mixing of multiple captured audio signals based on remote sensing of a real acoustic environment, where the remote sensing is performed using transmission/reflection/reception of sensing signals;

FIGS. 10A, 10B & 11A, 11B illustrate examples of automatic control of mixing of multiple captured audio signals based on remote sensing of a real acoustic environment, where the remote sensing is performed using different sensing signals;

FIG. 12 illustrates an example of a multi-media rendering system.

### DETAILED DESCRIPTION

FIG. 1 illustrates an example of a system 100 and also an example of a method 200. The system 100 and method 200 record a sound scene 10 and process the recorded sound scene to enable an accurate rendering of the recorded sound scene as a rendered sound scene for a listener at a particular position (the origin) within the recorded sound scene 10.

In this example, the origin of the sound scene is at a microphone 120. In this example, the microphone 120 is static. It may record one or more channels, for example it may be a microphone array.

In this example, only a single static microphone 120 is illustrated. However, in other examples multiple static microphones 120 may be used independently. In such circumstances the origin may be at any one of these static microphones 120 and it may be desirable to switch, in some circumstances, the origin between static microphones 120 or to position the origin at an arbitrary position within the sound scene.

The system 100 also comprises one or more portable microphones 110. The portable microphone 110 may, for example, move with a sound source within the recorded sound scene 10. This may be achieved, for example, using a boom microphone or, for example, attaching the microphone to the sound source, for example, by using a Lavalier microphone. The portable microphone 110 may record one or more recording channels.

FIG. 2 schematically illustrates the relative positions of the portable microphone (PM) 110 and the static microphone (SM) 120 relative to an arbitrary reference point (REF). The position of the static microphone 120 relative to the reference point REF is represented by the vector x. The position of the portable microphone PM relative to the reference point REF is represented by the vector y. The relative position of the portable microphone 110 from the static microphone SM is represented by the vector z. It will be understood that z=y−x. As the static microphone SM is static, the vector x is constant. Therefore, if one has knowledge of x and tracks variations in y, it is possible to also track variations in z. The vector z gives the relative position of the portable microphone 110 relative to the static microphone 120 which is the origin of the sound scene 10. The vector z therefore positions the portable microphone 110 relative to a notional listener of the recorded sound scene 10.

There are many different technologies that may be used to position an object including passive systems where the positioned object is passive and does not produce a signal and active systems where the positioned object produces a signal. An example of a passive system, used in the Kinect™ device, is when an object is painted with a non-homogenous pattern of symbols using infrared light and the reflected light is measured using multiple cameras and then processed, using the parallax effect, to determine a position of the object. An example of an active system is when an object has a transmitter that transmits a radio signal to multiple receivers to enable the object to be positioned by, for example, trilateration. An example of an active system is when an object has a receiver or receivers that receive a radio signal from multiple transmitters to enable the object to be positioned by, for example, trilateration.

When the sound scene 10 as recorded is rendered to a user (listener) by the system 100 in FIG. 1, it is rendered to the listener as if the listener is positioned at the origin of the recorded sound scene 10. It is therefore important that, as the portable microphone 110 moves in the recorded sound scene 10, its position z relative to the origin of the recorded sound scene 10 is tracked and is correctly represented in the rendered sound scene. The system 100 is configured to achieve this.

In the example of FIG. 1, the audio signals 122 output from the static microphone 120 are coded by audio coder 130 into a multichannel audio signal 132. If multiple static microphones were present, the output of each would be separately coded by an audio coder into a multichannel audio signal.

The audio coder 130 may be a spatial audio coder such that the multichannels 132 represent the sound scene 10 as recorded by the static microphone 120 and can be rendered giving a spatial audio effect. For example, the audio coder 130 may be configured to produce multichannel audio signals 132 according to a defined standard such as, for example, binaural coding, 5.1 surround sound coding, 7.1 surround sound coding etc. If multiple static microphones were present, the multichannel signal of each static microphone would be produced according to the same defined standard such as, for example, binaural coding, 5.1 surround sound coding, 7.1 and in relation to the same common rendered sound scene.

The multichannel audio signals 132 from one or more of the static microphones 120 are mixed by mixer 102 with multichannel audio signals 142 from the one or more portable microphones 110 to produce a multi-microphone multichannel audio signal 103 that represents the recorded sound scene 10 relative to the origin and which can be rendered by an audio decoder corresponding to the audio coder 130 to reproduce a rendered sound scene to a listener that corresponds to the recorded sound scene when the listener is at the origin.

The multichannel audio signal 142 from the, or each, portable microphone 110 is processed before mixing to take account of any change in position of the portable microphone 110 relative to the origin at the static microphone 120.

The audio signals 112 output from the portable microphone 110 are processed by the positioning block 140 to adjust for a change in position of the portable microphone 110 relative to the origin at the static microphone 120. The positioning block 140 takes as an input the vector z or some parameter or parameters dependent upon the vector z. The vector z represents the relative position of the portable microphone 110 relative to the origin at the static microphone 120.

The positioning block 140 may be configured to adjust for any time misalignment between the audio signals 112 recorded by the portable microphone 110 and the audio signals 122 recorded by the static microphone 120 so that they share a common time reference frame. This may be achieved, for example, by correlating naturally occurring or artificially introduced (non-audible) audio signals that are present within the audio signals 112 from the portable microphone 110 with those within the audio signals 122 from the static microphone 120. Any timing offset identified by the correlation may be used to delay/advance the audio signals 112 from the portable microphone 110 before processing by the positioning block 140.

The positioning block 140 processes the audio signals 112 from the portable microphone 110, taking into account, for example, the relative orientation (Arg(z)) of that portable microphone 110 relative to the origin at the static microphone 120.

The audio coding of the static microphone audio signals 122 to produce the multichannel audio signal 132 assumes a particular orientation of the rendered sound scene relative to an orientation of the recorded sound scene and the audio signals 122 are encoded to the multichannel audio signals 132 accordingly.

The relative orientation Arg (z) of the portable microphone 110 in the recorded sound scene 10 is determined and the audio signals 112 representing the sound object are coded to the multichannels defined by the audio coding 130 such that the sound object is correctly oriented within the rendered sound scene at a relative orientation Arg (z) from the listener. For example, the audio signals 112 may first be mixed or encoded into the multichannel signals 142 and then a transformation T may be used to rotate the multichannel audio signals 142, representing the moving sound object, within the space defined by those multiple channels by Arg (z).

The portable microphone signals 112 may additionally be processed to control the perception of a distance D of the sound object from the listener in the rendered sound scene, for example, to match the distance |z| of the sound object from the origin in the recorded sound scene 10. This can be useful when binaural coding is used so that the sound object is, for example, externalized from the user and appears to be at a distance rather than within the user's head, between the user's ears. The positioning block 140 modifies the multichannel audio signal 142 to modify the perception of distance.

FIG. 3 illustrates a module 170 which may be used, for example, to perform the functions of the positioning block 140 in FIG. 1. The module 170 may be implemented using circuitry and/or programmed processors.

The Figure illustrates the processing of a single channel of the multichannel audio signal 142 before it is mixed with the multichannel audio signal 132 to form the multi-microphone multichannel audio signal 103. A single input channel of the multichannel signal 142 is input as signal 187.

The input signal 187 passes in parallel through a “direct” path and one or more “indirect” paths before the outputs from the paths are mixed together, as multichannel signals, by mixer 196 to produce the output multichannel signal 197. The output multichannel signal 197, for each of the input channels, are mixed to form the multichannel audio signal 142 that is mixed with the multichannel audio signal 132.

The direct path represents audio signals that appear, to a listener, to have been received directly from an audio source and an indirect path represents audio signals that appear to a listener to have been received from an audio source via an indirect path such as a multipath or a reflected path or a refracted path.

A distance block 160 by modifying the relative gain between the direct path and the indirect paths, changes the perception of the distance D of the sound object from the listener in a rendered sound scene.

Each of the parallel paths comprises a variable gain device 181, 191 which is controlled by the distance block 160.

The perception of distance can be controlled by controlling relative gain between the direct path and the indirect (decorrelated) paths. Increasing the indirect path gain relative to the direct path gain increases the perception of distance.

In the direct path, the input signal 187 is amplified by variable gain device 181, under the control of the distance block 160, to produce a gain-adjusted signal 183. The gain-adjusted signal 183 is processed by a direct processing module 182 to produce a direct multichannel audio signal 185.

In the indirect path, the input signal 187 is amplified by variable gain device 191, under the control of the positioning block 160, to produce a gain-adjusted signal 193. The gain-adjusted signal 193 is processed by an indirect processing module 192 to produce an indirect multichannel audio signal 195.

The direct multichannel audio signal 185 and the one or more indirect multichannel audio signals 195 are mixed in the mixer 196 to produce the output multichannel audio signal 197.

The direct processing block 182 and the indirect processing block 192 both receive direction of arrival signals 188. The direction of arrival signal 188 gives the orientation Arg(z) of the portable microphone 110 (moving sound object) in the recorded sound scene 10.

The direct module 182 may, for example, include a system 184 similar to that illustrated in FIG. 4A that rotates the single channel audio signal, gain-adjusted input signal 183, in the appropriate multichannel space producing the direct multichannel audio signal 185.

The system 184 uses a transfer function to perform a transformation T that rotates multichannel signals within the space defined for those multiple channels by Arg(z), defined by the direction of arrival signal 188. For example, a head related transfer function (HRTF) interpolator may be used for binaural audio.

The indirect module 192 may, for example, be implemented as illustrated in FIG. 4B. In this example, the direction of arrival signal 188 controls the gain of the single channel audio signal, the gain-adjusted input signal 193, using a variable gain device 194. The amplified signal is then processed using a static decorrelator 199 and then a system 198 that applies a static transformation T to produce the output multichannel audio signals 195. The static decorrelator in this example uses a pre-delay of at least 2 ms. The transformation T rotates multichannel signals within the space defined for those multiple channels in a manner similar to the system 184 but by a fixed amount. For example, a static head related transfer function (HRTF) interpolator may be used for binaural audio.

It will therefore be appreciated that the module 170 can be used to process the portable microphone signals 112 and perform the function of changing the relative position (orientation Arg(z) and/or distance |z|) of a sound object, represented by a portable microphone audio signal 112, from a listener in the rendered sound scene.

FIG. 5 illustrates an example of the system 100 implemented using an apparatus 400, for example, a portable electronic device. The portable electronic device may, for example, be a hand-portable electronic device that has a size that makes it suitable to carried on a palm of a user or in an inside jacket pocket of the user.

In this example, the apparatus 400 comprises the static microphone 120 as an integrated microphone but does not comprise the one or more portable microphones 110 which are remote. However, in other examples the apparatus does not comprise the static microphone or microphones. In this example, but not necessarily all examples, the static microphone 120 is a microphone array.

The apparatus 400 comprises an external communication interface 402 for communicating externally to receive data from the remote portable microphone 110 and any additional static microphones or portable microphones. The external communication interface 402 may, for example, comprise a radio transceiver.

A positioning system 450 is illustrated. This positioning system 450 is used to position the portable microphone 110 relative to the static microphone 120. In this example, the positioning system 450 is illustrated as external to both the portable microphone 110 and the apparatus 400. It provides information dependent on the position z of the portable microphone 110 relative to the static microphone 120 to the apparatus 400. In this example, the information is provided via the external communication interface 402, however, in other examples a different interface may be used. Also, in other examples, the positioning system may be wholly or partially located within the portable microphone 110 and/or within the apparatus 400.

The positioning system 450 provides an update of the position of the portable microphone 110 with a particular frequency and the terms ‘accurate’ and ‘inaccurate’ positioning of the sound object should be understood to mean accurate or inaccurate within the constraints imposed by the frequency of the positional update. That is accurate and inaccurate are relative terms rather than absolute terms.

The apparatus 400 wholly or partially operates the system 100 and method 200 described above to produce a multi-microphone multichannel audio signal 103.

The apparatus 400 provides the multi-microphone multichannel audio signal 103 via an output communications interface 404 to an audio output device 300 for rendering.

In some but not necessarily all examples, the audio output device 300 may use binaural coding. Alternatively or additionally, in some but not necessarily all examples, the audio output device may be a head-mounted audio output device.

In this example, the apparatus 400 comprises a controller 410 configured to process the signals provided by the static microphone 120 and the portable microphone 110 and the positioning system 450. In some examples, the controller 410 may be required to perform analogue to digital conversion of signals received from microphones 110, 120 and/or perform digital to analogue conversion of signals to the audio output device 300 depending upon the functionality at the microphones 110, 120 and audio output device 300. However, for clarity of presentation no converters are illustrated in FIG. 5.

Implementation of a controller 410 may be as controller circuitry. The controller 410 may be implemented in hardware alone, have certain aspects in software including firmware alone or can be a combination of hardware and software (including firmware).

As illustrated in FIG. 5 the controller 410 may be implemented using instructions that enable hardware functionality, for example, by using executable instructions of a computer program 416 in a general-purpose or special-purpose processor 412 that may be stored on a computer readable storage medium (disk, memory etc) to be executed by such a processor 412.

The processor 412 is configured to read from and write to the memory 414. The processor 412 may also comprise an output interface via which data and/or commands are output by the processor 412 and an input interface via which data and/or commands are input to the processor 412.

The memory 414 stores a computer program 416 comprising computer program instructions (computer program code) that controls the operation of the apparatus 400 when loaded into the processor 412. The computer program instructions, of the computer program 416, provide the logic and routines that enables the apparatus to perform the methods illustrated in FIG. 1-12. The processor 412 by reading the memory 414 is able to load and execute the computer program 416.

As illustrated in FIG. 5, the computer program 416 may arrive at the apparatus 400 via any suitable delivery mechanism 430. The delivery mechanism 430 may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 416. The delivery mechanism may be a signal configured to reliably transfer the computer program 416. The apparatus 400 may propagate or transmit the computer program 416 as a computer data signal.

Although the memory 414 is illustrated as a single component/circuitry it may be implemented as one or more separate components/circuitry some or all of which may be integrated/removable and/or may provide permanent/semi-permanent/dynamic/cached storage.

Although the processor 412 is illustrated as a single component/circuitry it may be implemented as one or more separate components/circuitry some or all of which may be integrated/removable. The processor 412 may be a single core or multi-core processor.

The foregoing description describes a system 100 and method 200 that can position a sound object within a rendered sound scene. The system as described has been used to position the sound source within the rendered sound scene, so that the rendered sound scene accurately reproduces a position of the sound source in the recorded sound scene. The inventors have realized that the recorded sound scene may not accurately represent a sound scene that would be heard by an observer at the origin of the rendered sound scene. This may be because the acoustic environment of the sound scene from the perspective of the origin of the rendered sound scene is different than the acoustic environment of the sound scene from the perspective of the microphones recording the sound scene.

For example, referring back to FIG. 2, there is a direct path from a sound source at the portable microphone PM to the origin of the rendered sound scene at the static microphone SM. The sound scene heard by an observer at the origin would change depending upon whether or not there is an obstruction in that path. The system 100 described thus far does not account for the effect of such an obstruction. Rendering the sound scene without taking into account the obstructed path means that the sound scene rendered will not be an accurate reproduction of the sound scene from the position of the origin. This may, for example, be important if a user is simultaneously viewing a video of the scene from the position of the origin while listening to the rendered sound scene from that position. There will be a mismatch between the scene as viewed and as heard. For example when a sound source associated with the portable microphone (PM) 110 moves behind a wall so that it is no longer visible from the origin in the video, then the visual scene changes but the rendered sound scene does not. This problem is addressed below.

FIG. 6 illustrates an example of a method 500 for enabling automatic control of mixing of multiple captured audio signals.

At block 502, the method 500 comprises remotely sensing a real acoustic environment, in which multiple audio signals are captured.

At block 504, the method comprises enabling automatic control of mixing of the multiple captured audio signals based on the remote sensing of the real acoustic environment in which the multiple audio signals were captured.

The method 500 enables the correct rendering of sound objects from a perspective of an origin of a rendered sound scene taking into account the real acoustic environment of the sound object in the recorded sound scene 10. The listener to the rendered sound scene hears the recorded sound scene as if they were positioned at the origin of the rendered sound scene in the recorded sound scene 10. The rendering takes into account the real acoustic environment of the sound object and adapts to changes in the real acoustic environment of the sound object.

FIG. 7 illustrates an example of the system 100 previously described in relation to FIG. 1. However, in this example of the system 100, the positioning block 140 has been replaced by conditioning block 740.

The conditioning block 740 is configured to operate in the same manner as the positioning block 140 when there is no requirement to automatically control mixing of the multiple captured audio signals 142, 132 based on remote sensing of the real acoustic environment. However, when there is a requirement to control mixing of the multiple captured audio signals 142, 132 based on the remote sensing of the real acoustic environment, then the conditioning block 740 conditions the audio signals 112 recorded by the portable microphone 110 in a manner different to that performed by the positioning block 140.

The conditioning block 740 may be configured to adjust for any time misalignment between the audio signals 112 recorded by the portable microphone 110 and the audio signals 122 recorded by the static microphone 120 so that they share a common time reference frame. This may be achieved, for example, by correlating naturally occurring or artificially introduced (non-audible) audio signals that are present within the audio signals 112 from the portable microphone 110 with those within the audio signal 122 from the static microphone 120. Any timing offset identified by the correlation may be used to delay/advance the audio signals 112 from the portable microphone 110 before processing by the conditioning block 740.

The system 100 illustrated in FIG. 7 is similar to the system 100 illustrated in FIG. 1 in that audio signals 112 output from the portable microphone 110 are processed by the conditioning block 740 to adjust the audio signals 112. As illustrated in FIG. 7, the conditioning block 740 takes as an input a position 741 of the portable microphone 110, for example, the vector z or some parameter or parameters dependent upon the vector z. The vector z represents the relative position of the portable microphone 110 relative to the origin (the static microphone 120).

The acoustic environment sensor 750 may be, for example, at the origin of the rendered sound scene, for example, at the static microphone 120, or it may be positioned elsewhere but provide information about the real acoustic environment of the portable microphone 110 from the perspective of the origin of the rendered sound scene.

The real acoustic environment is the physical environment. The real acoustic environment from the perspective of the origin of the rendered sound scene is the physical environment that impacts acoustically upon sound travelling from the sound object (e.g. the portable microphone 110) to the origin of the rendered sound scene, which in some examples may be at the position of the static microphone 120. The real acoustic environment may, for example, impact upon the number and quality of acoustic paths for sound to travel from the sound object (e.g. at the portable microphone 110) to the origin of the rendered sound scene.

The conditioning block 740 takes as a further input sensor information 742 relating to sensing of a real acoustic environment by the acoustic environment sensor 750.

The conditioning block 740 processes the audio signals 112 from the portable microphone 110 taking into account, for example, the relative orientation (Arg(z)) of the portable microphone 110 relative to an origin of the rendered sound scene, the relative distance |z| of the portable microphone 110 relative to the origin of the rendered sound scene, and the sensed real acoustic environment of the portable microphone 110 relative to the origin of the rendered sound scene.

The conditioning block 740 is used to control mixing of the multi-channel audio signal 142 and the multi-channel audio signal 132 by conditioning the multi-channel audio signal 142, representing the moving sound object, to compensate for the real acoustic environment of the moving sound object.

The conditioning by conditioning block 740 may occur in real time commensurate with the capturing of the audio signals 112 by the portable microphone 110 or it may occur at a later time using a recorded version of the portable microphone signals 112 and corresponding recorded values of the position 741 of the portable microphone 110 and the recorded sensor information 742 for the real acoustic environment of the portable microphone 110. The conditioning performed by the conditioning block 740 may therefore be shifted in time and space relative to the capturing of the portable microphone signals 112 and/or relative to the rendering of the sound scene.

In some but not necessarily all examples, the acoustic environment sensor 750 may be configured to sense all or part of a real ambient acoustic environment of the portable microphone 110 (sound object). The real ambient acoustic environment is the environment that impacts upon the likelihood of sound recorded by the portable microphone 110 reaching the origin of the rendered sound scene by multi-paths, for example, by reflection off neighboring objects, walls, ceilings, etc. The acoustic environment sensors 750 may sense the real ambient acoustic environment by, for example, transmitting sensing signals into the real acoustic environment and detecting the reflection of the sensing signals from the real acoustic environment. The detection of such reflected sensing signals may enable the conditioning block 740 to map at least some of the real acoustic environment. In this way, it may be possible for the conditioning block 740 to determine when a particularly sound-absorbing environment is near to/behind the portable microphone 110 but is not obstructing a direct path from the portable microphone 110 to the origin of the rendered sound scene. In this scenario, the conditioning block 740 may adapt the multi-channel audio signal 142 so that an indirect component of the signal (echo) is reduced relative to a direct component of the signal. Likewise, if the conditioning block 740 determines that there is a particularly sound-reflective environment near to/behind the portable microphone 110 but not obstructing the path from the portable microphone 110 to the origin of the rendered sound scene, then the conditioning block 740 may increase the indirect component (echo) of the multi-channel audio signal 142 relative to the direct component.

The acoustic environment sensor 750 may also be configured to sense a real line-of-sight acoustic environment of the portable microphone 110 (sound object). The real line-of-sight acoustic environment of the portable microphone 110 relates to the likelihood of a sound recorded by the portable microphone 110 reaching the origin of the rendered sound scene directly. As the portable microphone 110 is associated with a sound object, in some examples it can be assumed that the portable microphone 110 and the sound object are co-located and therefore the real line-of-sight acoustic environment is the likelihood that sound from the sound object co-located with the portable microphone 110 can reach the origin of the rendered sound scene directly in a line-of-sight path. The acoustic environment sensor 750 is therefore configured to detect whether or not there is an obstruction in the acoustic environment between the portable microphone 110 (sound object) and the origin of the rendered sound scene, and, in some examples, if there is an obstruction, to sense the acoustic characteristics of the obstruction. This real line-of-sight acoustic environment may, for example, arise if an object passes between the origin of the rendered sound scene and the portable microphone 110, if the portable microphone 110 moves behind an obstruction which may occur, for example, if a person wearing the portable microphone 110 moves behind an obstruction or if they turn so that their body forms an obstruction. The obstruction of the real line-of-sight acoustic environment, may be compensated for by the conditioning block 740 by increasing the indirect component (multi-path) of the multi-channel signals 142 relative to the direct component of the multi-channel audio signals 142, while simultaneously reducing the amplitude/intensity of the multi-channel audio signals 142 associated with the portable microphone 110.

FIG. 8 illustrates an example of a conditioning block 740 illustrated in FIG. 7. In this example, the conditioning block 740 is a module which may be used, to perform the functions of the conditioning block 740 in FIG. 7. The module 740 may be implemented using circuitry and/or programmed processors.

The figure illustrates the processing of a single channel of the multi-channel audio signal 142 before it is mixed with the multi-channel audio signal 132 to form the multi-microphone multi-channel audio signal 103. A single input channel of the multi-channel signal 142 is input as signal 187.

The input signal 187 passes in parallel through a “direct” path and one or more “indirect” paths before the outputs from the paths are mixed together, as multi-channel signals, by mixer 196 to produce the output multi-channel signal 197. The output multi-channel signals 197, for each of the input channels, are mixed to form the multi-channel audio signal 142 that is mixed with the multi-channel audio signal 132.

The direct path represents audio signals that appear, to a listener at an origin of the rendered sound scene, to have been received directly from an audio source and an indirect path represents audio signals that appear to a listener, at an origin of the rendered sound scene, to have been received from an audio source via an indirect path such as a multi-path or a refracted path.

A controller block 760, by modifying the absolute gain of the direct path, the absolute gain of the indirect path(s), the relative gain between the direct path and the indirect path(s), and the parameters of the indirect path(s) changes a perception of the sound object, represented by the portable microphone signals 112, from a perspective of a listener at an origin of the rendered sound scene.

Each of the parallel paths comprises a variable gain device 181, 191 which is controlled by the controller block 760 via control signals 771, 772.

The controller block 760 takes as its inputs the position 741 of the portable microphone 110 and sensor information 742 characterizing the acoustic environment of the portable microphone 110 from the acoustic environment sensor 750.

The perception of intensity can be controlled by controlling the absolute gain of the direct path and/or the indirect (decorrelated) paths via control signals 771, 772. The perception of a clear, unobstructed path between the portable microphone 110 (sound object) and the origin of the rendered sound scene can be increased by increasing the gain of the direct path relative to the indirect path(s). The perception of an obstruction between the portable microphone 110 (sound object) and the origin of the rendered sound scene may be provided by decreasing the absolute gain of the direct path and the indirect paths and also increasing the indirect path gain relative to the direct path gain via control signals 771, 772. Alternatively or in addition, filtering such as low-pass filtering may be applied to simulate the attenuation of high frequencies when a sound passes through a wall, for example. The perception of an echo inducing environment in the vicinity of the portable microphone 110 may be controlled by controlling the relative gain between the direct path and the indirect paths, for example increasing the relative gain of the direct path via control signals 771, 772. Alternatively or in addition, extra reverb effect may be applied to create a stronger reverberation effect.

In the direct path, the input signal 187 is amplified by variable gain device 181, under the control of the control signal 771 from the controller block 760 to produce a gain-adjusted signal 183. The gain-adjusted signal 183 is processed by a direct processing module 182 to produce a direct multi-channel audio signal 185.

In each indirect path, the input signal 187 is amplified by a different variable gain device 191, under the control of a different control signal 772 from the controller block 760, to produce gain-adjusted signals 193. The gain-adjusted signals 193 are processed by indirect processing modules 192 to produce indirect multi-channel audio signals 195.

The direct multi-channel audio signal 185 and the one or more indirect multi-channel audio signals 195 are mixed in the mixer 196 to produce the output multi-channel signal 197.

The direct processing block 182 and the indirect processing block 192 both receive a separate control signal 761, 762. The control signal 761 provided to the direct processing block 182 corresponds to the signal 188 illustrated in FIG. 4A. It may, for example, be a direction of arrival signal giving the orientation of the portable microphone 110 (moving sound object) in the recorded sound scene. The direct module 182 may, for example, include a module 184 similar to that illustrated in FIG. 4A that rotates the single channel audio signal, gain-adjusted input signal 183, in the appropriate multi-channel space producing the direct multi-channel audio signal 185. The module 184 uses a transfer function to perform a transformation T that rotates the multi-channel signals within the space, as previously described.

The indirect module 192 may, for example, be implemented as previously described in relation to FIG. 4B. The control signal 762 provided by the controller module 760 corresponds to the signal 188 in FIG. 4B and controls the gain of the single channel audio signal, the gain-adjusted input signal 193, using a variable gain device 194. The amplified signal is then processed using a static decorrelator 199 and a module 198 then applies a static transformation T to produce the output multi-channel audio signal 195. In this example, the static decorrelator uses a pre-delay of at least 2 milliseconds.

In some examples, it may be possible to have multiple different indirect paths each with a different indirect module 192. Each separate indirect path may, for example, have a indirect module 192 that has a different static decorrelator, for example, a static decorrelator 199 with a different pre-delay. In some examples, the control signal(s) 762 may be used to control which of the indirect paths 192 are used and/or the relative gain of each of the indirect paths relative to each other.

It will therefore be appreciated that the controller module 760 can be used to process the portable microphone signals 112 and perform conditioning dependent upon the real audio environment.

It should also be appreciated, that when conditioning based upon the real audio environment is used, the controller 760 may, in addition, perform the function of the positioning block 140 and that when conditioning of the signal based upon the audio environment is not required, then the controller 760 performs the function of the positioning block 140.

The controller 760 is able through the sensor information 742 to remotely sense a real acoustic environment in which multiple audio signals are captured. In some, but not necessarily all, examples the controller 760 is configured to map a sensed acoustic environment to a recorded sound scene comprising multiple sound objects to determine a relationship of the sensed acoustic environment to the multiple sound objects in the recorded sound scene from a perspective of an origin of a rendered sound scene. In this example, the controller module 760 receives a position 741 providing the position of the portable microphone 110. The controller module 760 is able to determine the origin in the rendered sound scene, the position of the portable microphone 110 in the rendered sound scene and to determine via the sensor information 742 the real acoustic environment of the portable microphone 110. The controller module 760 is configured to enable automatic control of mixing of the audio signal representing the sound object associated with the portable microphone 110 to condition that sound object for an effect of the sensed acoustic environment on the sound object from the perspective of the origin of the rendered sound scene. For example, as previously described, the controller module 760 is configured to control the absolute and relative gains of the direct and indirect paths of each channel of the portable microphone signals 112.

The controller module 760 is also configured, based upon the sensor information 742, to switch on and switch off conditioning of the portable microphone signals 112 based upon the real acoustic environment. If conditioning of the portable microphone signals 112 based upon the sensed acoustic environment is performed, then the controller module 760 controls the conditioning by, for example, controlling the absolute and relative gains of the direct and indirect paths of each channel of the portable microphone signals 112. It will be appreciated that the controller module 760 is able to adapt the conditioning of the portable microphone signals 112 based upon adaptations to the acoustic environment determined by the acoustic environment sensor 750 provided to it by the sensor information 742. In this way, variations over time of the real acoustic environment in the recorded sound scene also result in changes in the rendered sound scene. In some, but not necessarily all, examples if there is a sudden change to the real acoustic environment then the controller module 760 may apply an adaptation to the conditioning of the portable microphone signals 112 more gradually so that there is not a sudden change in the audio characteristics of the rendered sound scene. However, this gradual adaptation may be a controllable parameter which may be adjusted by a user so that in other circumstances abrupt transition may occur in the audio characteristics of the rendered sound scene.

The acoustic environment sensor 750 is a sensor that tests the acoustic environment of the portable microphone 110 (sound object). The testing of an acoustic environment may typically involve the transmission of a sensing signal and the reception of a response signal. The response signal may be, for example, a version of the sensing signal that has been adapted by the acoustic environment by for example, transmission through the real acoustic environment or reflection from the real acoustic environment. The acoustic environment may therefore be considered to be a transfer function that operates upon the sensing signal to produce the response signal. The selection of the characteristics of the sensing signal, where it is transmitted from, and where the response signal is detected are design considerations that may be varied.

In the examples of FIGS. 9A, 9B, 10A, 10B and 11A, 11B a video camera 900 is positioned at an origin O of a rendered sound scene. The video camera 900 images the recorded sound scene and, in particular, the person wearing the portable microphone 110. It is important that there is no incongruity between the rendered audio sound scene and the visual scene recorded by the camera. As the portable microphone 110 is local to the sound object carrying the portable microphone the sound object as recorded by the portable microphone 110 does not necessarily represent the sound object as should be perceived at the origin O of the rendered sound scene. For example, if an obstruction 910 passes between the portable microphone 110 and the origin O of the rendered sound scene at the camera 900 then the obstruction 910 will have an impact on the visual scene as recorded by the camera 900 and should therefore also have a consequential impact on the rendered sound scene at the origin O. The conditioning block 740 as previously described causes this change in the rendered sound scene as perceived from the origin O of the rendered sound scene.

In each of the examples, an active transmitter device transmits a sensing signal 902 and a receiver device receives a response signal 904 based upon the impact of the acoustic environment on the sensing signal 902.

In the example of FIGS. 9A and 9B, the camera 900 is the transmitter device transmitting the sensing signal 902 which is reflected by the acoustic environment (or not) as the response signal 904 which is then detected by the receiver device, also at the camera 900. In the example of FIG. 9A, there is no audio obstruction between the camera 900 and the portable microphone 110. In this example, there may be no or little response signal 904 from the acoustic environment. In other examples, where the real ambient acoustic environment is particularly reflective, there may be a response signal 904 detected by the camera 900. In the example of FIG. 9B, an audio obstruction 910 intervenes in the path between the camera 900 and the portable microphone 110. In this example there is a strong reflection of the sensing signal 902 from the audio obstruction 910 to produce the response signal 904 detected at the camera 900. It will be appreciated that the timing of the response signal 904 relative to the sensing signal 902 and the intensity of the response signal 904 relative to the sensing signal 902 is different in FIG. 9B than it is in FIG. 9A. This timing and intensity information may be used as the sensing information 742. It is therefore possible for the conditioning module 740 to detect a change in the real acoustic environment of the portable microphone 110 and to adapt the conditioning of the portable microphone signals 112 as previously described.

In the example of FIGS. 10A and 10B, the camera 900 is the transmitter device transmitting the sensing signal 902 and the portable microphone 110 is the receiver device receiving the response signal 904 which is the sensing signal 902 after it has passed through the acoustic environment in the line-of-sight between the camera 900 and the portable microphone 110. The portable microphone 110, in this example, is configured to transmit a reply signal 920 to the camera 900, for example using radio waves or some other communication technology that will not be affected by an acoustic obstruction 910 in the line-of-sight between the camera 900 and the portable microphone 110. In the example of FIG. 10A, while there is no acoustic obstruction 910, the sensing signal 902 is transmitted by the camera 900 and is received, without significant interference, as the response signal 904 at the portable microphone 110. The portable microphone 110, in this example, is able to receive the response signal 904 and provide information concerning the response signal 904 to the camera 900 via the reply signal 920. The camera 900 is therefore able to use information concerning the sensing signal 902 transmitted by it and the response signal 904 received at the portable microphone 110 to create the sensing information 742. In the example of FIG. 10A the signals 902,904 will be very similar. However, in the example of FIG. 10B, an acoustic obstruction 910 is placed between the camera 900 and the portable microphone 110 and prevents all or some of the sensing signal 902 reaching the portable microphone 110 as the response signal 904. The reply signal 920 provided by the portable microphone 110 in FIG. 10B is therefore very different to the reply signal 920 provided in the example of FIG. 10A. The camera 900 receives the adapted reply signal 920 as sensing information 742 and the conditioning block 740 conditions the portable microphone signal 112 accordingly.

In the example of FIGS. 11A and 11B, the system is similar to that illustrated in FIGS. 10A and 10B except that the transmitter of the sensing signal 902 is the portable microphone 110 and the receiver of the response signal 904 is the camera 900. The sensing signal 902 is adapted by the acoustic environment between the portable microphone 110 and the camera 900 to produce the response signal 904. In the example of FIG. 11A, the received response signal 904 has characteristics similar to transmitted sensing signal 902 and the camera 900 is therefore able to determine that there is no acoustic obstruction in the line-of-sight between the portable microphone 110 and the camera 900. In the example of FIG. 11B, acoustic obstruction 910 completely or partially blocks the sensing signal 902 so that only a reduced or no response signal 904 is received at the camera 900. The reduced response signal 904 or the absence of a response signal 904 may be used as sensing information 742. In this example the conditioning block 740 responds to the reduced/absent response signal 904 by changing the conditioning applied to the portable microphone signal 112.

It will be appreciated from the embodiments of FIGS. 9 to 11, that in each of these embodiments the remote sensing of a real acoustic environment in which multiple audio signals are captured, comprises receiving a remote sensing signal dependent upon the real acoustic environment in which the multiple audio signals are captured. In the examples of FIGS. 9A and 9B, the remote sensing signal is the response signal 904. In the examples of FIGS. 10A and 10B the remote sensing signal is the reply signal 920. In the example of FIGS. 11A and 11B the remote sensing signal is the response signal 904.

It should be appreciated that in both of the examples of FIGS. 9 and 10, remotely sensing a real acoustic environment in which multiple audio signals are captured, comprises transmitting a sensor signal (sensing signal 902) and detecting a consequent signal as the remote sensing signal. In the example of FIG. 9, the consequent signal is a response signal 904, i.e. the reflected sensing signal 902. In the example of FIGS. 10A and 10B, the consequent signal is the reply signal 920 transmitted by the portable microphone 110.

In both the examples of FIGS. 10 and 11, the remote sensing signal is a signal transmitted by a sound object. In the example of FIGS. 10A and 10B, the remote sensing signal is the reply signal 920 transmitted by the portable microphone 110 and in the example of FIGS. 11A and 11B the remote sensing signal is the sensing signal 902 transmitted by the portable microphone 110.

It will be appreciated from the foregoing that in the example of FIGS. 9A and 9B the portable microphone 110 is passive concerning the sensing of the audio environment. The camera 900 transmits the sensing signals 902 which are passively reflected by the acoustic environment and the reflected signals are detected as the response signal 904 by the camera 900. The portable microphone 110 is therefore passive and not involved at all in sensing the audio environment.

In the examples of FIGS. 10 and 11, the portable microphone 110 is active in the sensing of the acoustic environment. In the example of FIGS. 10A and 10B, the portable microphone 110 receives the response signal 904 and transmits the reply signal 920 and in the examples of FIGS. 11A and 11B the portable microphone 110 produces the sensing signal 902.

In the preceding examples, the sensing signal 902 may be, for example, a radar signal, a lidar signal, for example infrared light, or a sonar system using sound outside the hearing range of humans. It will be appreciated from FIGS. 9B, 10B and 11B, that the sensing signal 902 may be used to detect the presence of a wall 910 between a user wearing a Lavalier microphone 110 and the camera 900.

Referring now to the examples of FIGS. 9A and 9B, the camera 900 may produce the sensing signal 902 as a directed, limited spread transmission and the acoustic environment sensor 750 may be configured to control a direction of transmission of the transmitted sensor signal (sensing signal 902) in dependence upon a position of the sound source (portable microphone 110). In this example the conditioning module 740 may use the position 741 of the portable microphone 110 to control the acoustic environment sensor 750 and a control signal will be sent from the conditioning module 740 to the acoustic environment sensor 750. In some examples, it may be for example possible for the sensing signal 902 to track the portable microphone 110 so that the acoustic environment sensor 750 receives only information concerning the line-of-sight acoustic environment between the camera 900 and the portable microphone 110. It will be appreciated that there are advantages to having a directed, narrow beam sensing signal 902 as it will not therefore be subject to interference outside the line-of-sight between the camera 900 and the portable microphone 110.

In a variation of the example illustrated in FIGS. 9A and 9B, the acoustic environment sensor 750 may be configured to project over a greater area, different spatially distinct sensing signals 902 simultaneously. The different spatially distinct signals are projected into the real acoustic environment and the acoustic environment sensor 750 detects the reflections. In some examples, if the different spatially distinct sensing signals 902 have characteristics that are also detectable in the reflected signals, it is possible to distinguish between different audio characteristics of different parts of the real acoustic environment. It may therefore be possible to record the real acoustic environment as a two-dimensional map that has different audio characteristics at different locations (different bearings).

In some examples, it may be possible to have a diversity receiver at the acoustic environment sensor 750 that receives a reflected sensing signal 902 as the response signal 904 at different, diverse, receiver locations. This additional information may be, for example, used to not only identify an audio characteristic of a portion of the real audio environment but also to estimate a distance of that portion of the real audio environment from the origin of the rendered scene. It is therefore possible, in this scenario, to create an audio depth map that maps the real audio environment in relation to its audio characteristics and the spatial variations of those audio characteristics as a three-dimensional map of the audio environment that has different audio characteristics at different three-dimensional locations. This sensing information 742 may be particularly useful to create additional effects such as echoes which are distance-dependent. This sensing information 742 may also be useful if the acoustic environment sensor 750 is not co-located with the camera 900. The sensing information 742 is output from the acoustic environment sensor 750 to the conditioning module 740 which uses this information to control the conditioning of the portable microphone signal 112.

In the examples of FIGS. 9 to 11, audio obstruction 910 may fully or partially obstruct the line-of-sight between the camera 900 and the portable microphone 110. As previously described in relation to those figures, it is possible for the acoustic environment sensor 750 or conditioning module 740 to discriminate between a full obstruction of the line-of-sight and a partial obstruction. The conditioning module 740 may, in the examples of FIGS. 9A, 10A and 11A, operate as the positioning module 140 of FIG. 1 and in the examples of FIGS. 9B, 10B and 11B, additionally operate to control the conditioning of the portable microphone signals 112 to take account of the different acoustic environment and, in particular, the presence of a full or partial obstruction of the direct line-of-sight acoustic path from the portable microphone 110 to the camera 900. The conditioning module 740 may, for example, be able to condition the portable microphone signals 112 in dependence upon the presence of an audio obstruction and/or in dependence upon the audio characteristics of the audio obstruction 910 by, for example, adjusting the absolute gains of the direct path component and the indirect path components and/or the relative gain of the direct path component and indirect paths component and/or by adapting the characteristics of the indirect paths as previously described in relation to FIG. 8. The characteristics of an audio obstruction may, for example, include its density and/or its size.

FIG. 12 illustrates an example of a rendering device 1000 which receives the multi-microphone multi-channel audio signal 103 produced by the system 100 illustrated in FIG. 7 and video 1001 provided by the camera 900 as illustrated in any of FIGS. 9-11. The rendering device 1000 synchronizes the audio 103 and the video 1001 to produce a multi-media output 1002 in which the video and audio are synchronized. In addition, as a result of the conditioning module 740 in the system 100 of FIG. 7, if an acoustic obstruction 910 moves between the camera 900 and the portable microphone 110, there is an automatic change to not only the image as recorded by the camera 900 as the obstruction passes between the camera 900 and the portable microphone 110 but there is also an automatic change in the rendered sound scene that has an origin at the camera 900 as a consequence of the processing of the conditioning block 740 of FIG. 7 and the method 500 of FIG. 6.

FIG. 5 illustrates an example of the system 100, comprising conditioning block 740 as illustrated in FIG. 7, implemented using an apparatus 400, for example, a portable electronic device.

It will be appreciated from the foregoing that the various methods 500 described may be performed by a computer program used by such an apparatus 400.

For example, an apparatus 400 may comprise:

at least one processor 412; and
at least one memory 414 including computer program code
the at least one memory 414 and the computer program code configured to, with the at least one processor 412, cause the apparatus 400 at least to perform:
enabling automatic control of mixing of multiple captured audio signals based on remote sensing of a real acoustic environment in which the multiple audio signals were captured.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

The blocks and methods illustrated in or described in relation to one or more of the FIGS. 1-12 may represent steps in a method and/or sections of code in the computer program 416. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

As used here ‘module’ refers to a unit or apparatus that excludes certain parts/components that would be added by an end manufacturer or a user.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class. It is therefore implicitly disclosed that a features described with reference to one example but not with reference to another example, can where possible be used in that other example but does not necessarily have to be used in that other example.

The term ‘capture’ or ‘record’ in relation to an audio signal describes the transformation of sound waves to an electrical signal by a microphone. It may in addition also describe the temporary or permanent storage of data representing the captured audio in a lossless or lossy format.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1-14. (canceled)

15. A method comprising:
remotely sensing a real acoustic environment, in which multiple audio signals are captured; and
enabling automatic control of mixing of the multiple captured audio signals based on the remote sensing of the real acoustic environment in which the multiple audio signals were captured.

16. A method as claimed in claim 15, wherein remotely sensing a real acoustic environment, in which multiple audio signals are captured, comprises projecting different spatially distinct signals into the real acoustic environment and detecting reflections of the different spatially distinct signals.

17. A method as claimed in claim 15, wherein remotely sensing a real acoustic environment, in which multiple audio signals are captured, comprises at least receiving a remote sensing signal dependent upon the real acoustic environment in which the multiple audio signals are captured.

18. A method as claimed in claim 17, wherein the remote sensing signal is a signal transmitted by a sound object.

19. A method as claimed in claim 17, wherein remotely sensing a real acoustic environment, in which multiple audio signals are captured, comprises transmitting a sensor signal and detecting a consequent signal as the remote sensing signal.

20. A method as claimed in claim 19, wherein transmitting a sensor signal comprises controlling a direction of transmission of the transmitted sensor signal in dependence upon a position of a sound source.

21. A method as claimed in claim 19, wherein the consequent signal is a reflected version of the transmitted sensor signal.

22. A method as claimed in claim 21, wherein the transmitted sensor signal is a radar signal.

23. A method as claimed in claim 15, wherein enabling automatic control of mixing of the multiple captured audio signals based on the remote sensing of the real acoustic environment in which the multiple audio signals were captured, comprises conditioning an audio signal captured at a portable microphone by modifying relative gain between a direct path component and an indirect path component of the audio signal captured at the portable microphone, wherein the direct path component represents an audio signal that appears, to a listener at an origin of a rendered sound scene, to have been received directly from a sound object associated with the portable microphone and the indirect path component represents an audio signal that appears to a listener at the origin of the rendered sound scene to have been received from the sound object associated with the portable microphone via an indirect path.

24. A method as claimed in claim 15, further comprising: remotely sensing a real acoustic environment, in which multiple audio signals are captured;
mapping a sensed real acoustic environment to a recorded sound scene comprising multiple sound objects to determine a relationship of the sensed acoustic environment to the multiple sound objects in the recorded sound scene from a perspective of an origin of a rendered sound scene; and
enabling automatic control of mixing of audio signals representing one of the multiple sound objects to condition the sound object for an effect of the sensed acoustic environment on the sound objects from the perspective of the origin of the rendered sound scene.

25. A method as claimed in claim 15, wherein enabling automatic control of mixing of the multiple captured audio signals based on the remote sensing of the real acoustic environment in which the multiple audio signals were captured, comprises enabling automatic control of mixing of audio signals representing a sound object to condition the sound object for the effect of an obstruction in the acoustic environment between the sound object and an origin of a rendered sound scene.

26. A method as claimed in claim 15, further comprising: sensing characteristics of an obstruction in the real acoustic environment between a first sound object and an origin of a rendered sound scene, wherein enabling automatic control of mixing of the multiple captured audio signals based on the remote sensing of the real acoustic environment in which the multiple audio signals were captured, comprises enabling automatic control of mixing of audio signals representing the first sound object in dependence upon the sensed characteristics of the obstruction in the real acoustic environment between the first sound object and the origin of the rendered sound scene.

27. A method as claimed in claim 15, wherein enabling automatic control of mixing of the multiple captured audio signals based on the remote sensing of the real acoustic environment in which the multiple audio signals were captured, comprises enabling automatic and gradual adaptation of mixing of the captured audio signals based on the remote sensing of a change in the real acoustic environment in which the audio signals were captured.

28. A method as claimed in claim 15 further comprising: automatically controlling the mixing of audio signals based on remote sensing of a real acoustic environment in which the audio signals were recorded.

29. An apparatus, comprising:
at least one processor; and
at least one memory including computer program code,
the at least one memory and the computer program code configured to, with the at least one processor, cause the apparatus to perform at least the following:
remotely sense a real acoustic environment, in which multiple audio signals are captured; and
enable automatic control of mixing of the multiple captured audio signals based on the remote sensing of the real acoustic environment in which the multiple audio signals were captured.

30. An apparatus as claimed in claim 29, wherein remotely sensing a real acoustic environment, in which multiple audio signals are captured, comprises at least receiving a remote sensing signal dependent upon the real acoustic environment in which the multiple audio signals are captured.

31. An apparatus as claimed in claim 30, wherein remotely sensing a real acoustic environment, in which multiple audio signals are captured, comprises transmitting a sensor signal and detecting a consequent signal as the remote sensing signal.

32. An apparatus as claimed in claim 31, wherein transmitting a sensor signal comprises controlling a direction of transmission of the transmitted sensor signal in dependence upon a position of a sound source.

33. An apparatus as claimed in claim 31, wherein the consequent signal is a reflected version of the transmitted sensor signal.

34. A computer readable medium comprising computer program code stored thereon, the computer readable medium and computer program code being configured to, when run on at least one processor, perform at least the following:
remotely sense a real acoustic environment, in which multiple audio signals are captured; and
enable automatic control of mixing of the multiple captured audio signals based on the remote sensing of the real acoustic environment in which the multiple audio signals were captured.
